(19) United States
(12) Patent Application Publication
(10) Pub. No.: US 2021/0407264 A1
(43) Pub. Date: Dec. 30, 2021

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Atsushi Kawano, Tokyo (JP); Shinji Yamamoto, Kanagawa (JP); Sho Saito, Saitama (JP); Akifumi Tanaka, Kanagawa (JP); Ichiko Mayuzumi, Kanagawa (JP)

(21) Appl. No.: 17/352,933

(22) Filed: Jun. 21, 2021

(30) Foreign Application Priority Data
Jun. 30, 2020 (JP) 2020-113015

(51) Int. Cl. G08B 13/196; G06K 9/00

(52) U.S. Cl. CPC G08B 13/19613; G06K 9/00771; G08B 13/19608; G06K 9/00369; G06K 9/00671

(57) ABSTRACT

An image processing apparatus that outputs information about a predetermined person includes an acquisition unit configured to acquire person information including an action history of a person detected from a video and product information corresponding to a target product possibly stolen from a store, an extraction unit configured to extract person information related to the target product corresponding to the acquired product information based on the product corresponding to the acquired product information and the action history included in the acquired person information, and an output unit configured to output a report including at least the person information extracted by the extraction unit and the product information corresponding to the target product.

### BACKGROUND

### Field

The present disclosure relates to an image processing apparatus, an image processing method, and a storage medium.

### Description of the Related Art

Monitoring systems have been introduced to prevent crimes or damage by stealing, not only in large stores but also in small retail stores. Installing a camera inside a store produces an effect of preventing a crime to some extent. However, the effect deteriorates over time. For example, in a store, a short inventory can remain unnoticed until inventory clearance or arrangement of items is performed, and then shoplifting damage is found, in many cases. In this case, a recorded video of the monitoring system is played back to confirm the damage by stealing, but this work consumes a lot of time. Besides, a stealing scene may not always recorded. The store often cannot discover a crime despite a time-consuming investigation and thus gives up pursuing.

To make such work of identifying a suspect easy, Japanese Patent Application Laid-Open No. 2017-40982 discusses a method of displaying an action of a recorded person in time series to identify a crime. In this method, features of a face or entire body are extracted beforehand from a person in a video of a monitoring camera, and the video is searched based on a condition such as an image of the face or entire body. Further, images are displayed in time series based on the action of the person, thereby assisting in work of finding out a suspect.

Using the search technique discussed in Japanese Patent Application Laid-Open No. 2017-40982 makes it possible to extract a person satisfying a condition, based on a feature of a subject. However, when, for example, a person suspected of shoplifting is searched for, it may be desirable to visually examine whether each of the extracted persons has committed an act, such as picking up a stolen product and putting the product in a bag, and this is time-consuming work.

### SUMMARY

To address the above-described issue, the present disclosure is directed to identifying a suspect quickly, in a case where stealing is found.

An image processing apparatus that outputs information about a predetermined person includes an acquisition unit configured to acquire person information including an action history of a person detected from a video and acquire product information corresponding to a target product possibly stolen from a store, an extraction unit configured to extract person information related to the target product corresponding to the acquired product information based on the product corresponding to the acquired product information and the action history included in the acquired person information, and an output unit configured to output a report including at least the person information extracted by the extraction unit and the product information corresponding to the target product.

Further features of the present disclosure will become apparent from the following description of exemplary embodiments with reference to the attached drawings.

### BRIEF DESCRIPTION OF THE DRAWINGS

FIG. 1A is a block diagram illustrating an example of a system configuration of an image processing apparatus.

FIG. 1B is a block diagram illustrating an example of a hardware configuration of the image processing apparatus.

FIG. 2 is a flowchart illustrating an example of a processing procedure of the image processing apparatus.

FIG. 3 is a flowchart illustrating an example of a recording and metadata storage processing procedure in the image processing apparatus.

FIG. 4 is a flowchart illustrating an example of a suspect identification and report creation processing procedure in the image processing apparatus.

FIG. 5 illustrates an example of a stolen product information input screen in the image processing apparatus.

FIG. 6 illustrates an example of a candidate person list screen in the image processing apparatus.

FIG. 7 illustrates an example of a candidate person action screen in the image processing apparatus.

FIG. 8 illustrates an example of a suspect report creation screen in the image processing apparatus.

### DESCRIPTION OF THE EMBODIMENTS

An exemplary embodiment of the present disclosure will be described in detail below with reference to the attached drawings. A configuration to be described in the following exemplary embodiment is only an example, and the present disclosure is not limited to the illustrated configuration.

In the present exemplary embodiment, a monitoring system installed in a retail store, such as a convenience store, will be described as an example of an image processing apparatus. The present system captures an image with a camera installed in the store, and holds recording information generated by a recording system and person information generated by image analysis processing. In a case where stealing has occurred, a suspect is identified using these pieces of information and a report including a captured image of the suspect is created.

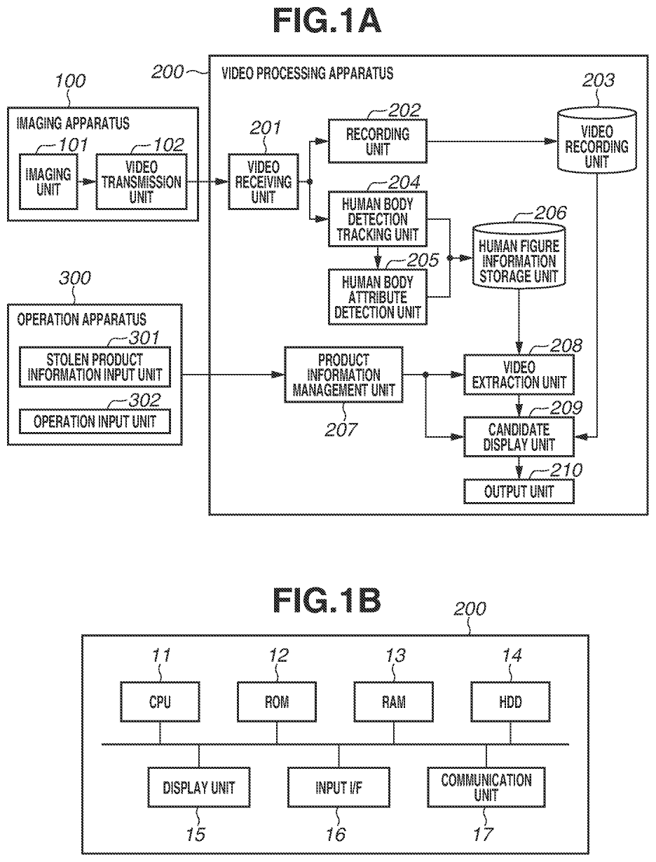

FIG. 1A is a block diagram illustrating an example of a system configuration of the monitoring system of the present exemplary embodiment. FIG. 1B is a block diagram illustrating an example of a hardware configuration of a video processing apparatus 200 according to the present exemplary embodiment. The present system includes an imaging apparatus 100, the video processing apparatus 200, and an operation apparatus 300.

The imaging apparatus 100 includes an imaging unit 101 and a video transmission unit 102. The imaging unit 101 includes an imaging lens, an imaging sensor such as a charge-coupled device (CCD) sensor or a complementary metal oxide semiconductor (CMOS) sensor, and a video signal processing unit that performs analog-to-digital (AD) conversion and predetermined signal processing. A video captured by the imaging unit 101 is converted into a still image (a frame image) at predetermined time intervals, and the frame image is transmitted to the video transmission unit 102. The video transmission unit 102 appends additional information, such as imaging apparatus information and time, to the received frame image, converts the frame image into data that can be transmitted on a network, and transmits the data to the video processing apparatus 200. Although only one imaging apparatus is illustrated in FIG. 1A, a plurality of imaging apparatuses may be connected.

A hardware configuration of the video processing apparatus 200 will now be described with reference to FIG. 1B.

The video processing apparatus 200 includes a central processing unit (CPU) 11, a read only memory (ROM) 12, a random access memory (RAM) 13, a hard disk drive (HDD) 14, a display unit 15, an input interface (I/F) 16, and a communication unit 17. The CPU 11 reads out a control program stored in the ROM 12 and executes various kinds of processing based on the control program. The RAM 13 works as a temporary storage area, such as a main memory or a work area for the CPU 11. The HDD 14 stores various data and various programs. The display unit 15 displays various kinds of information. The display unit 15 may be a display device integral with a touch panel. The input I/F 16 is an interface for inputting operation information of the operation apparatus 300. The communication unit 17 performs processing for communication with an external apparatus, such as the imaging apparatus 100, via a wired or wireless network.

The CPU 11 reads out a program stored in the ROM 12 or the HDD 14 and executes this program, so that the function and the processing of the video processing apparatus 200 described below are implemented. In another example, the CPU 11 may read out a program stored in a storage medium, such as a secure digital (SD) card, in place of the ROM 12 or the like.

In the present exemplary embodiment, processing illustrated in each flowchart described below is executed by one memory (the ROM 12) using one processor (the CPU 11) in the video processing apparatus 200. However, the processing may be executed in a different manner. For example, the processing illustrated in each flowchart described below can be executed by a plurality of processors and a plurality of RAMs, ROMs, and storages operating together. Further, part of the processing may be executed using a hardware circuit. Furthermore, the function and the processing of the video processing apparatus 200 described below may be implemented using a processor different from the CPU. For example, the function and the processing may be implemented using a graphics processing unit (GPU) instead of the CPU.

A functional configuration of the video processing apparatus 200 will now be described with reference to FIG. 1A. The video processing apparatus 200 has the following configuration.

A video receiving unit 201 receives a frame image transmitted from the video transmission unit 102 included in the imaging apparatus 100 via the communication unit 17, and transmits the received frame image to a recording unit 202 and a human body detection tracking unit 204.

The recording unit 202 adds information, such as imaging apparatus information and time information, to the frame images transmitted at predetermined intervals from the video receiving unit 201, converts the frame images into a video in a predetermined format, and records the video in a video recording unit 203. If frame rate conversion of the frame image is desirable, the video recording unit 203 performs processing of converting the frame rate.

The human body detection tracking unit 204 performs detection processing and tracking processing for a person appearing in the frame image transmitted from the video receiving unit 201. Any method may be used to detect the person from the image in the detection processing for the person. Examples of the method include a method of pattern matching between an edge and a person shape on an image, a method using a convolutional neural network (CNN), and a background difference method. The person detected by the human body detection tracking unit 204 is expressed by the coordinates of two points that are an upper left point and a lower right point of a rectangle surrounding the person, using the upper left point as the origin of coordinates. The tracking processing for the person associates the detected persons in a plurality of images in a time direction. Any method may be used for the tracking processing. For example, the tracking processing predicts the location of the person in the current frame image from the center position and the motion vector of the person included in the previous frame image, and associates the persons based on the predicted location of the person and the center position of the person in the current frame image. The associated persons are assigned an identification (ID) and handled as the same person. Data (metadata) obtained by the human body detection tracking unit 204 is output to a human body attribute detection unit 205, and also stored into a person information storage unit 206.

The human body attribute detection unit 205 performs human body attribute detection processing and person action recognition processing, for each of the assigned person IDs, based on the information (metadata) obtained by the human body detection tracking unit 204.

The human body attribute means characteristics, such as age, gender, height, build, hairstyle features, and facial features, obtained mainly from the appearance of the person.

The action recognition means the acquisition of information indicating an action history including a degree of suspiciousness, a dwell time in front of a store shelf, contact with a product, a product purchase status, and an in-store dwell time of the person.

The degree of suspiciousness means a numerical value representing the degree of a specific act, e.g., an unusual behavior (a suspicious behavior) such as looking around restlessly, fumbling through a bag, or putting an object in a bag or pocket.

The information indicating the dwell time in front of a store shelf is acquired by associating an action or movement path of the person, such as how long and in front of which shelf the person has stayed, with the person ID. A product on a shelf and the person ID can be associated by having associated the shelf information and the person. Moreover, information indicating the approach of the person to the shelf can be acquired.

Further, information indicating actions, such as picking up a product, putting a product in a basket, picking up and then returning a product to a shelf can also be acquired as data representing the person's action. These pieces of information can be extracted from an image, and may be acquired by, for example, a method of detecting a touch on a product by the person by performing attitude detection and orientation estimation. These pieces of information may also be extracted not only by the method of acquiring information from the image, but also, for example, a technique of detecting a touch on a product using a sensor attached to a shelf.

The information indicating the product purchase status is acquired by, for example, creating a movement history of the person using a plurality of imaging apparatuses and determining whether the person has passed through a cash register. In a case where the acquisition of the movement history of the person is difficult, the information indicating the product purchase status can be acquired by determining whether the person appears in a camera installed at the cash register. In this determination method, a technique is used, such as person collation of determining whether the persons are the same based on the face and the appearance of the person. Further, a product purchased by the person can be associated with the person by linking the person with point of sales (POS) data, so that the obtained data can be stored as product information indicating the product purchased by the person.

The information indicating the in-store dwell time is acquired by, for example, a method of acquiring the time from when the person enters the store to when the person leaves the store using a camera installed at the entrance of the store, or a method of acquiring an in-store movement history of the person by performing person collation using a plurality of cameras inside the store.

As described above, the data (metadata) obtained by the human body attribute detection unit 205 is stored in the person information storage unit 206, together with the information obtained by the human body detection tracking unit 204.

A product information management unit 207 manages a product code, appearance information, a shelf number where a product is placed, and information about the imaging apparatus 100 for imaging a product, and stores these pieces of information in the HDD 14. Further, the product information management unit 207 inputs information indicating a thieved product (a stolen product) from the operation apparatus 300.

A video extraction unit 208 extracts a video satisfying a condition from the videos stored in the video recording unit 203, based on the product information from the product information management unit 207 and the information from the person information storage unit 206.

A candidate display unit 209 controls display of the video extracted by the video extraction unit 208 on the display unit 15.

An output unit 210 creates a report in which stolen product information, suspect information, and suspect confirmation information are combined, and outputs the created report.

The operation apparatus 300 includes a stolen product information input unit 301 and an operation input unit 302. The stolen product information input unit 301 inputs thieved product (stolen product) information, based on an operation by a user. The information input here is transmitted to the video processing apparatus 200. Further, the operation input unit 302 is used as an interface for operating the video processing apparatus 200. In a case where the display unit 15 is a display device equipped with a touch panel, the stolen product information input unit 301 may be included in the video processing apparatus 200.

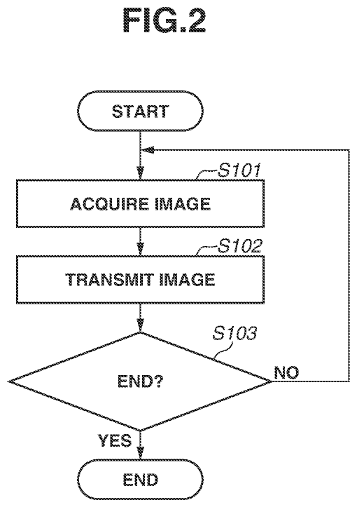

Processing of the imaging apparatus 100 of the present exemplary embodiment will now be described with reference to a flowchart in FIG. 2.

In step S101, the imaging unit 101 in the imaging apparatus 100 captures a video and acquires a frame image at a predetermined frame rate.

In step S102, the video transmission unit 102 appends additional information, such as an imaging apparatus specific number and time information, to the image acquired by the imaging unit 101, processes the frame image into an image in a format that can be transmitted on a network, and transmits the processed frame image to the video processing apparatus 200.

In step S103, the imaging apparatus 100 determines whether a request for ending the image transmission is issued. If the request for ending is issued (YES in step S103), the processing ends. If the request for ending is not issued (NO in step S103), the processing returns to step S101 to acquire the frame image.

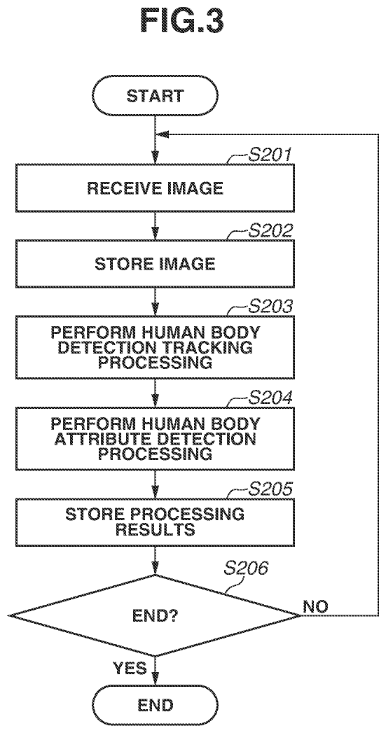

Recording processing and metadata storage processing in the video processing apparatus 200 of the present exemplary embodiment will now be described with reference to a flowchart in FIG. 3.

In step S201, the video receiving unit 201 in the video processing apparatus 200 receives the frame image transmitted from the imaging apparatus 100, thereby acquiring the frame image of the predetermined frame rate.

In step S202, the recording unit 202 accumulates the frame images acquired by the video receiving unit 201 and converts the accumulated frame images into a video in a predetermined format. The recording unit 202 then stores the converted video in the video recording unit 203, together with appended information, such as a video time stamp and an imaging apparatus number.

In step S203, the human body detection tracking unit 204 performs the detection processing and the tracking processing for a human body in the frame image acquired by the video receiving unit 201. The human body detection tracking unit 204 generates metadata that includes the coordinates of a rectangle on an image of the human body as a human body detection result, and a person ID as well as coordinates on an image as a tracking processing result.

In step S204, the human body attribute detection unit 205 performs the human body attribute detection processing, based on the metadata generated by the human body detection tracking unit 204. In this processing, the human body attribute detection unit 205 detects the attribute information of the human body, such as age, gender, height, build, hairstyle features, and facial features. The human body attribute detection unit 205 performs the person action recognition processing, and outputs a numerical value representing the degree of suspiciousness of a person. The human body attribute detection unit 205 acquires information including a dwell time in front of a store shelf, contact with a product, a product purchase status, and an in-store dwell time, from a plurality of frame images related to the person ID.

In step S205, the human body detection tracking unit 204 stores the metadata generated in step S203 into the person information storage unit 206. The human body attribute detection unit 205 stores the metadata generated in step S204 into the person information storage unit 206.

The processing up to this point is performed each time a series of frame images is acquired. In step S206, the video receiving unit 201 determines whether the reception of the frame images has ended. If the reception of the frame images has ended (YES in step S206), the processing ends. If the reception of the frame images has not ended (NO in step S206), the processing returns to step S201 to receive the frame image.

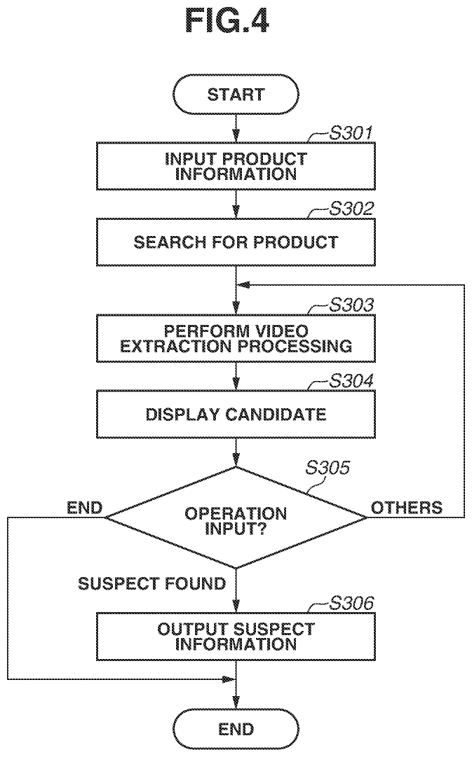

Suspect identification and suspect information output processing of the video processing apparatus 200 of the present exemplary embodiment will now be described with reference to a flowchart illustrated in FIG. 4 and FIGS. 5 to 8.

In step S301, the product information management unit 207 inputs information indicating a stolen product from the operation apparatus 300.

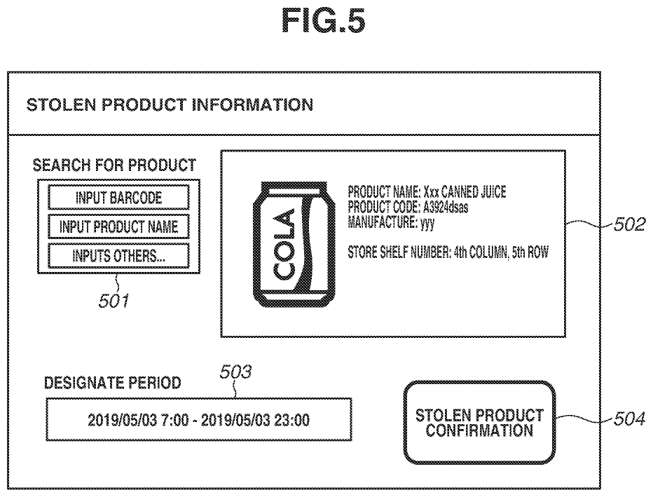

The suspect identification processing in the present system begins from the input of the information indicating the product (the stolen product) as a search target in step S301. The information indicating the stolen product is input from the stolen product information input unit 301 based on an operation on the operation apparatus 300 by the user. An example of a user input screen used here is illustrated in FIG. 5. As the method of inputting the information indicating the stolen product, there are various methods including a method of inputting a barcode data of a product by scan, a method of directly inputting a product name, a method of inputting a product code managed in a store, and a method of searching based on the location of a product shelf. FIGS. 5 to 8 each illustrate a screen to be displayed on the display unit 15 by the display control of the video extraction unit 208, and the method of inputting the information indicating the stolen product is selected in a product search menu 501 illustrated in FIG. 5. In the following description, the user selects barcode input. In the barcode input, the barcode of the same product as the stolen product is scanned using a barcode scanner (not illustrated). The stolen product information input unit 301 transmits the product information corresponding to the input barcode to the product information management unit 207.

In step S302, the product information management unit 207 identifies and searches for the product based on the input product information, and displays the search result on the display unit 15. A product information display portion 502 illustrated in FIG. 5 is a display example thereof, and displays information including a picture of the product, a brand name, a product code, a manufacture name, and a display location in a store. The user confirms that the displayed product is the stolen product, based on the information displayed in the product information display portion 502.

The user then inputs a conceivable affected period, in a period designation portion 503. The conceivable period is, for example, a period from the date of the previous inventory clearance to the date of the discovery of stealing. After inputting the product information and the conceivable affected period information, the user selects a stolen product confirmation button 504, and thereby the processing proceeds to step S303.

In step S303, the video extraction unit 208 performs video extraction processing, using the information stored in the person information storage unit 206, based on the information input by the user in step S302. In the video extraction processing, the video extraction unit 208 performs processing for a video corresponding to the conceivable affected period designated by the user in the period designation portion 503 in FIG. 5. The video extraction unit 208 extracts a person possibly having been in contact with the stolen product (e.g., a person having approached the stolen product), using extraction conditions described below, based on the metadata stored in the person information storage unit 206.

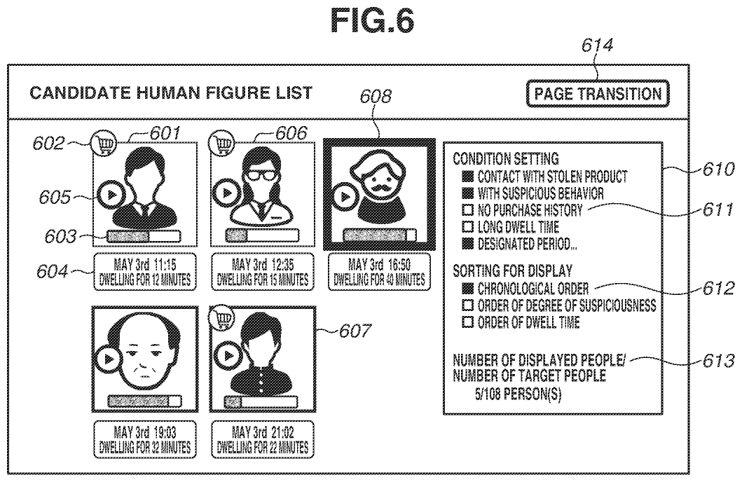

In step S304, the video extraction unit 208 displays information about the extracted person on the display unit 15, as a candidate person list as illustrated in FIG. 6. The information displayed here includes time information, a degree of suspiciousness, which is a numerical value representing a suspicious behavior, and the presence/absence of a purchase history, in addition to a thumbnail image of the person.

An example of a screen to be displayed by the video extraction unit 208 will be described with reference to FIG. 6. A thumbnail image 601 is the thumbnail image of the person extracted by the video extraction unit 208. The thumbnail image 601 is clipped from the frame images stored in the video recording unit 203. Here, the frame image in which the face of the person can be recognized is clipped, but, for example, the frame image at the time when the person is in contact with the stolen product may be clipped.

A purchase history mark 602 is provided to display the purchase history, and displays whether the extracted person has actually purchased the product at the store or left the store without buying anything. Such information can be reference information for identifying a suspect. The purchase history mark 602 is displayed when the purchase history of the person is present, and is not displayed when the person has left the store without buying anything. Whether the purchased product is the stolen product or other product may be set by the setting of the system. The information indicating the purchase history is acquired beforehand by the human body attribute detection unit 205 as the information indicating the product purchase status as described above, and is stored in the person information storage unit 206.

A degree-of-suspiciousness display bar 603 is provided to display the degree of suspiciousness. In FIG. 6, a value representing the highest degree of suspiciousness of the person is displayed with the degree-of-suspiciousness display bar 603, so that which one of the extracted persons has acted suspiciously is clearly displayed. As described above, the degree of suspiciousness is acquired beforehand by the human body attribute detection unit 205 and then stored in the person information storage unit 206, as with the information indicating the purchase history.

A time information display portion 604 displays the store entrance time and the in-store dwell time of the person. As with the purchase history and the degree of suspiciousness, these pieces of time information are acquired beforehand by the human body attribute detection unit 205 and then stored in the person information storage unit 206.

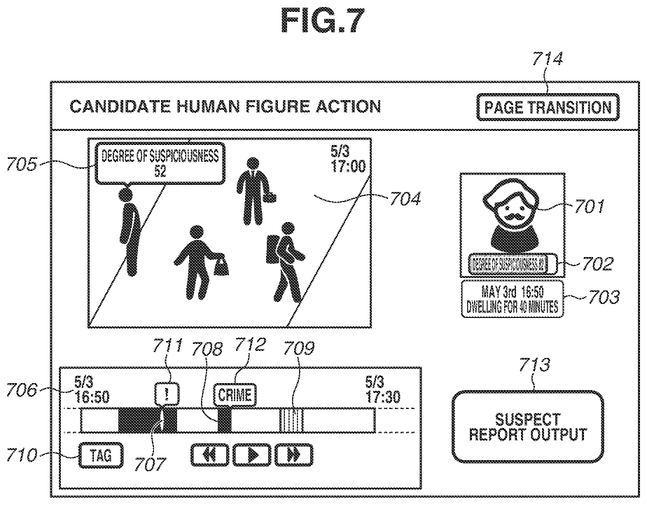

A playback button 605 is provided to play back the video captured during the in-store dwell time of the person. The user can confirm the person in the video stored in the video recording unit 203, by selecting the playback button 605. A video playback screen will be described below with reference to FIG. 7.

Thumbnail image frames 606 to 608 each display an image frame of the person to distinguish between the person confirmed in the played-back video captured during the in-store dwell time and the person for which the video has not played back yet among the extracted persons. Here, whether the video has been played back or not is indicated using the thickness of the image frame, but a determination method using color, such as a red frame, may be adopted. The thumbnail image frame 606 displays the person already confirmed in the played-back video, using a thin frame line as a played-back display frame. In FIG. 6, the thumbnail image frame 607 displays the person for which the video has not played back yet, using a medium thick frame line as a non-played back display frame. The thumbnail image frame 608 displays the person identified as a suspect or a suspicious person as a result of confirming the video, using a thick frame line as a probable person display frame. The probable person display frame (Bounding Box) is displayed for the person for which a suspect report described below is to be created, or the person to which a tag is appended at the time of the video playback.

User operations related to the display of the candidate person list are collectively displayed in a user operation portion 610. A person extraction condition setting portion 611 is an extraction-condition setting item for the user to designate conditions for the extraction of the person. The user can designate the extraction conditions by using items such as whether contact with the stolen product has occurred, whether a suspicious behavior at a degree corresponding to a predetermined value or more is present, whether the purchase history is present, the dwell time of a predetermined length or more, and changing the video search period. When these conditions are changed, the processing flow returns from step S305 to the video extraction processing in step S303 as will be described below. Afterward, in step S303, the video extraction processing is performed again based on the conditions changed by the user. In step S304, the extracted person is subsequently displayed again as illustrated in FIG. 6. The number of the candidate persons can be reduced by adding a condition in the person extraction condition setting portion 611, so that the time taken to identify a suspect can be reduced. For example, if a person having no purchase history is set as the extraction condition, a person who has actually purchased the product can be excluded from the candidate person list. Further, the least limited initial values can be set for the extraction conditions, so that, for example, all persons who have approached the stolen product can be displayed in the candidate person list.

A person display order portion 612 is an item for designating a display order in the candidate person list. The display order appropriate to each case, such as the chronological order, the order of degree of suspiciousness, or the order of dwell time, can be set as a way of identifying the suspect, so that the suspect can easily be identified.

A number-of-people display portion 613 displays the number of all the people before the extraction of the candidate person and the number of the currently displayed people. The user can readily recognize how many persons are the candidates based on the extraction conditions set in the person extraction condition setting portion 611.

The user can efficiently find out the suspect by reviewing the extraction conditions in the person extraction condition setting portion 611, and performing a sorting operation, thereby reducing the candidate persons. In a case where the user wants to confirm the detailed action of the person, the user selects the playback button 605 on each of the person thumbnails in this screen. To finish the suspect identification in a case where, for example, no suspect is found, the user selects a page transition button 614 to return to the stolen product information input screen illustrated in FIG. 5.

A screen that displays an action of the candidate person will now be described with reference to FIG. 7. In the candidate person list in FIG. 6, the user can confirm the details of the action of the candidate person by selecting the playback button 605 on the thumbnail image. An example of a screen for confirming the detailed action of the candidate person will be described with reference to FIG. 7.

A thumbnail image 701 is the thumbnail image of the candidate person selected by the user in the candidate person list illustrated in FIG. 6. A degree-of-suspiciousness display bar 702 is a bar indicating the degree of suspiciousness. A dwell time display portion 703 displays the store entrance time and the in-store dwell time of the person.

A video playback portion 704 displays a video captured in a period in which the candidate person is present. Since a plurality of persons can be present in the video, the candidate person is pointed out by a degree-of-suspicious display portion 705 for indicating the candidate person. The candidate person may be indicated by a rectangle surrounding the candidate person. Besides indicating the candidate person, the degree-of-suspicious display portion 705 simultaneously displays the degree of suspiciousness of the candidate person imaged at the time when the displayed image is captured. The degree of suspiciousness is a numerical value representing the detected suspicious behavior of the person, and therefore, the user can confirm what kind of action of the candidate person has made the degree of suspiciousness high, while confirming the video. The user can also select a video captured at the time when the degree of suspiciousness is high and confirm the selected video, by playing back the video while referring to the degree of suspiciousness.

An image playback operation portion 706 includes a typical playback control part including a playback button, a rewind button, and a forward button, and a bar displaying the timeline of the video of the candidate person.

A slide bar 707 indicates the playback time, and the user can play back the video captured at a desired time, by dragging the slide bar 707 with a mouse or the like.

A contact period 708 represents the period in which the user can confirm that the candidate person is holding (in contact with) the stolen product during the video period. A non-image-capturing period 709 represents the period in which the candidate person is not imaged because, for example, the candidate person is in a blind spot of the camera.

In the video, a tag can also be set in a frame image considered to be important or a frame image to be included in a report later. While confirming the frame images, the user stops at the frame image to set the tag, and then selects a tag button 710. When the tag button 710 is selected, the tag is set at a position corresponding to the applicable frame time. The types of the tag include an important tag 711 and a crime tag 712 that each can be selected by a mouse operation or the like. The important tag 711 is used, for example, in a case where a suspicious behavior is confirmed and to be examined later. The crime tag 712 is used as a tag to be appended when stealing is confirmed.

Referring back to FIG. 4, in step S305, a state of waiting for an operation by the user begins. In a case where the user selects an end button (not illustrated) without selecting a suspect report output button 713 (END in step S305), the processing ends. In a case where a page transition button 714 is selected by the user or the extraction condition is changed by the user in the person extraction condition setting portion 611 in the screen illustrated in FIG. 6 (OTHERS in step S305), the processing returns to step S303 to continue the processing. In a case where the suspect report output button 713 is selected (SUSPECT FOUND in step S305), the processing proceeds to step S306. In step S306, the output unit 210 performs suspect report creation processing.

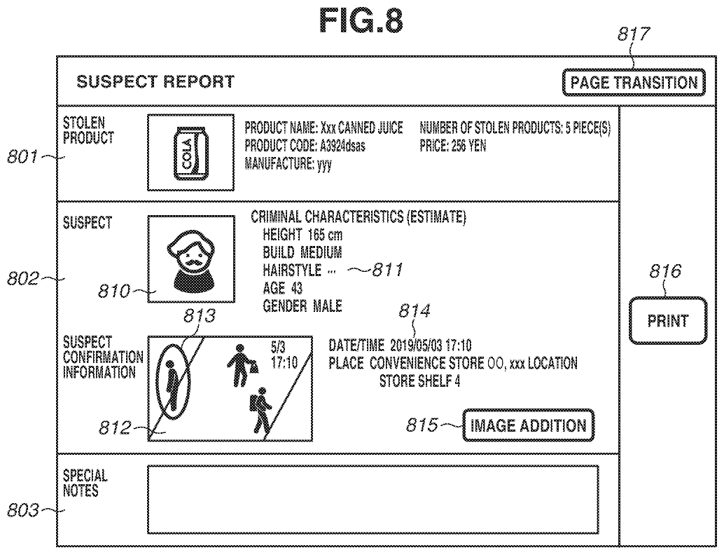

The suspect report creation processing performed in step S306 will now be described with reference to FIG. 8. In the suspect report, necessary information is input by the output unit 210 based on the information input so far by the user to identify the suspect and the video extraction information, and the user can further add an image or a comment. In the suspect report creation processing, the output unit 210 receives the information from the video extraction unit 208 and creates the suspect report based on the received information. FIG. 8 is an example of the created suspect report.

A stolen product information display portion 801 displays information extracted from the product information management unit 207 based on the information input in the stolen product information input screen illustrated in FIG. 5.

A suspect information display portion 802 displays information about the identified suspect. A suspect image display portion 810 displays a thumbnail image of the identified suspect. A suspect feature display portion 811 displays external features of the suspect. The external features are displayed based on the information generated by the human body attribute detection unit 205.

A suspect crime image display portion 812 displays an image to which the crime tag 712 is appended in the candidate person action screen in FIG. 7. Further, a suspect frame 813 identifying the suspect is displayed on this screen to make the target suspect noticeable.

An additional information display portion 814 displays the information added to the image, including the recording time, the place, and the product shelf information. In a case where the user wants to further add an image to the suspect report, the user selects an image addition button 815 thereby transitioning to the candidate person action screen in FIG. 7, and selects an image in this screen, so that the user can add the selected image. Even in this case, the additional information including the recording time and the place is displayed in the additional information display portion 814.

A supplementary information display portion 803 is a space to be used when the user wants to add supplementary information and a comment to the suspect report. For the information of this suspect report, the product information and the suspect information are extracted, and the user can further add information and a comment. When a print button 816 is selected by the user in step S306 in a state where the suspect report information illustrated in FIG. 8 is displayed on the display unit 15, the output unit 210 instructs an external printing apparatus (not illustrated) to print the report. When a page transition button 817 is selected, the current screen transitions to, for example, the stolen product information input screen illustrated in FIG. 5, so that the user can return to the suspect identification work for the next stolen product.

As described above, the present system stores the metadata based on the human body attribute detection together with the recorded video, and inputs the stolen product information, thereby creating the candidate suspect list, and performing the suspect identification work quickly and easily. The user can therefore quickly and easily perform the work of identifying the suspect and creating the report.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-113015, filed Jun. 30, 2020, which is hereby incorporated by reference herein in its entirety.

What is claimed is:

1. An image processing apparatus that outputs information about a predetermined person, the image processing apparatus comprising:
an acquisition unit configured to acquire person information including an action history of a person detected from a video, and product information corresponding to a target product possibly stolen from a store;
an extraction unit configured to extract person information related to the target product corresponding to the acquired product information, based on the product corresponding to the acquired product information and the action history included in the acquired person information; and
an output unit configured to output a report including at least the person information extracted by the extraction unit and the product information corresponding to the target product.

2. The image processing apparatus according to claim 1, wherein the extraction unit extracts a person having approached the target product corresponding to the acquired product information, from the acquired person information, as a candidate person.

3. The image processing apparatus according to claim 2, wherein the output unit outputs the report including a person selected by a user from the extracted candidate persons, as a suspect of a stealing act.

4. The image processing apparatus according to claim 1, further comprising a control unit configured to display the video on a display unit.

5. The image processing apparatus according to claim 4, further comprising a recording unit configured to record the video,
wherein the control unit displays a video corresponding to the extracted person information.

6. The image processing apparatus according to claim 1, wherein the acquisition unit acquires the product information corresponding to the target product, based on information about a product managed in the store.

7. The image processing apparatus according to claim 1, wherein the output unit outputs the report, based on a predetermined format.

8. The image processing apparatus according to claim 1, wherein the person information includes at least one of a movement path, a contacted product, and a degree of a specific action of the person.

9. The image processing apparatus according to claim 1, wherein the extraction unit extracts person information corresponding to a person having been in contact with the target product corresponding to the acquired product information, as the person information related to the target product.

10. The image processing apparatus according to claim 1, wherein the extraction unit extracts person information corresponding to a person whose degree of a specific action is greater than or equal to a predetermined value, as the person information related to the target product corresponding to the acquired product information.

11. The image processing apparatus according to claim 1, wherein the extraction unit extracts the person information related to the target product corresponding to the acquired product information, except for person information corresponding to a person having purchased the target product corresponding to the acquired product information.

12. The image processing apparatus according to claim 1, further comprising a designation unit configured to designate a period to search the video,
wherein the extraction unit extracts the person information related to the product corresponding to the acquired product information in the period designated by the designation unit.

13. The image processing apparatus according to claim 1, wherein the acquisition unit acquires a result of detecting and tracking a person from the video, and a human body attribute according to an appearance of the person, as the person information.

14. An image processing method of outputting information about a predetermined person, the image processing method comprising:
acquiring person information including an action history of a person detected from a video, and acquiring product information corresponding to a target product possibly stolen from a store;
extracting person information related to the product corresponding to the acquired product information, based on the target product corresponding to the acquired product information and the action history included in the acquired person information; and
outputting a report including at least the extracted person information and the product information corresponding to the target product.

15. A non-transitory storage medium storing an instruction that when executed by one or more processors configures the one or more processors to execute an image processing method of outputting information about a predetermined person, the image processing method comprising:
acquiring person information including an action history of a person detected from a video, and acquiring product information corresponding to a target product possibly stolen from a store;
extracting person information related to the product corresponding to the acquired product information, based on the product corresponding to the acquired product information and the action history included in the acquired person information; and
outputting a report including at least the extracted person information and the product information corresponding to the target product.
